(19) United States
(12) Patent Application Publication
(10) Pub. No.: US 2022/0180431 A1
(43) Pub. Date: Jun. 9, 2022

(54) A BLOCKCHAIN-BASED CREDIT MANAGEMENT SYSTEM

(71) Applicant: ISLAMIC DEVELOPMENT BANK INSTITUTE, Jeddah (SA)

(72) Inventors: Sami AL SUWAILEM, Jeddah (SA); Hilal HUSSEIN, Jeddah (SA); Mahmoud BEKRI, Jeddah (SA)

(73) Assignee: ISLAMIC DEVELOPMENT BANK INSTITUTE, Jeddah (SA)

(21) Appl. No.: 17/600,407

(22) PCT Filed: Jan. 2, 2020
(86) PCT No.: PCT/IB2020/050003

§ 371 Date: Sep. 30, 2021

(30) Foreign Application Priority Data
Aug. 23, 2019 (SG) 10201907802Y

(51) Int. Cl. G06Q 40/02

(52) U.S. Cl. CPC G06Q 40/025; G06Q 2220/00

(57) ABSTRACT

A computer-implemented blockchain-based credit management method and system, the method includes: receiving one or more loan repayments from a user in a first transaction, the loan repayments being in respect of a first loan issued by a lender; receiving a fee from the user in a second transaction associated with the first transaction; transferring the loan repayments to the lender; transferring the fee to a loan insurance fund; registering at least the first transaction in a first blockchain of a blockchain network; determining a number of credit worthiness points based on at least timeliness of the first transaction relative to a first loan repayment schedule; and associating the number of credit worthiness points with the user in a third transaction and registering the third transaction in a second blockchain of the blockchain network.

### FIELD OF THE INVENTION

The present application relates to a blockchain-based credit management system that integrates (i) credit information and history, (ii) credit incentives & rating, and (iii) credit insurance.

### BACKGROUND OF THE INVENTION

Credit is vital for the growth of the economy and sustainability of business. However, credit is information-intensive, and requires information before, during, and after financing is provided. For this reason, credit registries (or credit bureaus) are of great importance in facilitating credit financing.

Another institution that facilitates credit financing is insurance. Credit insurance helps debtors in difficulties to honour their obligations and, by doing so, supports the pool of debtors, helping them remain viable. Credit rating is a more advanced form of credit information that helps investors and institutions assess the credit risk of deficit units seeking financing.

However, insurance can provide negative incentives to pay on time. The use of peer pressure to encourage timely repayment is difficult, if not impossible, for large pools of customers. Further, the quality of information for traditional credit registries is not always reliable. Moreover, it can be difficult to determine whether a late paying customer who pleads financial difficulty (e.g. facing insolvency) is genuinely unable to pay or is simply procrastinating. Currently, lenders and financing institutions deal with three important tools of credit provision (viz. credit history, credit rating and credit insurance) separately: this can not only increase cost, but also risks inconsistency.

As used herein, the term “loan” refers to any form of financing, including credit-sales, leasing and loans. The term “lender” refers to any financing person or institution, including banks, finance companies and leasing companies.

### SUMMARY OF THE INVENTION

The following presents a simplified summary of the present invention, in order to provide a basic understanding of some of its aspects. The summary is not an extensive overview of the present invention. It is neither intended to identify key or critical elements of the present invention nor to delineate the scope of the present invention. The following summary merely presents some concepts of the present invention in a simplified form as a prelude to the description below.

According to a first aspect of the invention, there is provided a computer-implemented blockchain-based credit management method, comprising:
receiving one or more loan repayments from a user in a first transaction, the loan repayments being in respect of a first loan issued by a lender, such as a bank or other lending institution (in, for example, standard currency or in cryptocurrency);
receiving a fee from the user in a second transaction associated with the first transaction;
transferring the loan repayments to the lender;
transferring the fee to a loan insurance fund;
registering at least the first transaction in a first blockchain of a blockchain network;
determining a number of credit worthiness points based on at least timeliness of the first transaction relative to a first loan repayment schedule; and
associating the number of credit worthiness points with the user in a third transaction and registering the third transaction in a second blockchain of the blockchain network.

In an embodiment, the method further comprises determining a credit rating for the user (such as by a digital contract or contracts, and whether or when the points are assigned or on demand) based on at least a total number of credit worthiness points allocated to or held by the user, as registered in the second blockchain, and associated with the user.

In an embodiment, the method further comprises verifying as valid a credit score calculated or accessed by the lender of a loan application of the user. The method may further comprise approving the loan application with to join the network when the credit score is valid.

In an embodiment, the method further comprises registering the credit rating in the first blockchain, in the second blockchain, and/or in a credit rating blockchain of the blockchain network. It should be noted that the term ‘transaction’ is used to refer broadly to any event that may be recorded in a blockchain. Also, it should be understood that references to recording such a transaction in a blockchain are intended to embrace the recordal of that transaction across a plurality of blockchains.

In an embodiment, the method includes registering the second transaction in a third blockchain of the blockchain network. The first transaction may include the second transaction. In an embodiment, the method registering the second transaction in the first blockchain.

In an embodiment, the method further comprises paying to the lender from the loan insurance fund one or more outstanding loan repayments in response to receipt of data indicative of the user omitting to make the corresponding loan repayments (that is, according to the prescribed schedule for making that repayment). For example, the method may comprise paying to the lender from the loan insurance fund a plurality of outstanding loan repayments in response to receipt of data indicative of the user omitting to make the corresponding loan repayments; in some examples, up to a predefined maximum number of loan repayments, e.g. two, after which legal action may be taken by or on behalf of the lender to recover the unrepaid balance of the loan (including the two installments paid by the insurance fund). In another embodiment, the method further comprises paying to the lender from the loan insurance fund some or all of an outstanding balance of the first loan in response to receipt of verification data indicating that the user has been verified as unable to make one or more loan repayments (subject to the insurance fund's financial reserves).

In an embodiment, the method further comprises verifying the credit score calculated or accessed by the lender of a user requesting financing. In an example, the method includes declining a membership of a user when a credit score determined or accessed by the lender is invalid or cannot be verified. Thus, the term “credit score” refers to a score calculated or accessed by a lender to evaluate a loan application; if the score is above a certain threshold (typically set by that lender), the loan application is accepted; otherwise it is rejected. In this embodiment, the system generally does not itself calculate such credit scores (i.e. evaluating a credit risk of a loan applicant). Rather, the user is evaluated by the lender or other financing institution and, once approved, he or she is permitted to join the CES network subject to the network verifying that that credit score (as determined or accessed by the lender) is valid and the member therefore is an acceptable risk to the group. During the Subprime bubble, many banks were recklessly scoring applicants which made the loan portfolio highly risky: in this example, the CES verifies the credit-risk of each new member before granting membership (that is, access to the network's functionality) in order to minimize possible moral hazard due to the insurance mechanism. Hence, the institution performs the scoring in accordance to its own methodology and risk-parameters (or accesses such a score from a trusted external agency); In this example, the network verifies the validity of the final credit score. To protect the privacy of the institution, the verification process may involve the processes described below by reference to FIGS. 4A and 4B.

In an embodiment, the method further comprises allocating the user to a borrower group of users; and providing said users in the borrower group with access to the first blockchain at least sufficient to retrieve or view loan repayment information associated with the users of the borrower group. In an example, the loan repayment information includes at least loan repayment timing information indicative of the timeliness of loan repayments made by the users in the borrower group. In an example, the method includes providing said users in the borrower group with access to cryptographic keys configured to access the loan repayment information. The method may comprise issuing said users in the borrower group with cryptographic keys configured to retrieve or view: i) loan repayment information; ii) credit worthiness points; and/or iii) credit ratings, associated with the users of the borrower group.

In an embodiment, the method includes determining a greater number of credit worthiness points when a repayment is made before expiry of a predefined grace period following a repayment due date than when made after the expiry of the predefined grace period. In an embodiment, the method includes determining a greater number of credit worthiness points when a repayment is made before a repayment due date than after the due date. In an embodiment, the method further comprises determining a reduction in credit worthiness points after expiry of a predefined grace period following a repayment due date. Network members may optionally also gain credit worthiness points by actively participating in the verification activities required by the blockchain network. Points gained by network activities preferably do not exceed a predefined limit (e.g. 5%) of the total points gained by the user, so that the total points are predominantly determined by the timely repayments of loans.

According to a second aspect of the invention, there is provided a computer program comprising computer program code configured, when loaded into a computing system and executed thereon, to control the computing system to perform the method of the first aspect. According to this aspect, there is also provided a computer readable medium (which may be non-transitory), comprising such a computer program.

According to a third aspect of the invention, there is provided a blockchain-based credit management system, comprising:
a funds management engine configured to receive one or more loan repayments from a user in a first transaction, the loan repayments being in respect of a first loan issued by a lender, to receive a fee from the user in a second transaction associated with the first transaction, to transfer the loan repayments to the lender, and to transfer the fee to a loan insurance fund;
a blockchain controller configured to register at least the first transaction in a first blockchain of a blockchain network; and
a credit rating system configured to determine a number of credit worthiness points based on at least timeliness of the first transaction relative to a first loan repayment schedule, to associate the number of credit worthiness points with the user in a third transaction;
wherein the blockchain controller is further configured to register the third transaction in a second blockchain of the blockchain network.

In an embodiment, the credit rating system is further configured to determine a credit rating for the user (whether and when the points are assigned or on demand) based on at least a total number of credit worthiness points allocated to or held by the user, as registered in the second blockchain, and to associate the credit rating with the user.

In an embodiment, the blockchain controller is further configured to register the second transaction in a third blockchain of the blockchain network, or to register the second transaction in the first blockchain.

In an embodiment, the funds management engine is further configured to pay to the lender from the loan insurance fund one or more outstanding loan repayments in response to receipt of data indicative of the user omitting to make the corresponding loan repayments. In a certain embodiment, the funds management engine is further configured to pay to the lender from the loan insurance fund some or all of an outstanding balance of the first loan in response to receipt of verification data indicating that the user has been verified as unable to make one or more loan repayments. In some embodiments, the blockchain controller is further configured to register the credit rating in the first blockchain, in the second blockchain, and/or in a credit rating blockchain of the blockchain network.

In an embodiment, the system further comprises a score verification manager configured to verify the score of a loan application from the user for a second loan subsequent to the determining of the credit rating, wherein the loan application is approved subject to the credit rating being at or above a predefined threshold. Thus, in this embodiment, the system does not evaluate loan applications; the lender does. However, the system verifies accepted application to ensure its financial sustainability.

In an embodiment, the system is further configured to allocate the user to a borrower group of users, and to provide said users in the borrower group with access to the first blockchain at least sufficient to retrieve or view loan repayment information associated with the users of the borrower group. The system may optionally be configured to provide the users in the borrower group with access to cryptographic keys configured to retrieve or view: i) loan repayment information; ii) credit worthiness points; and/or iii) credit ratings, associated with the users of the borrower group. In an example, the system further comprises a transaction viewer controllable to employ the secret keys to retrieve and display or otherwise output the loan repayment information, credit worthiness points and/or credit ratings.

In an embodiment, the credit rating system is further configured (i) to determine a greater number of credit worthiness points if a repayment is made before expiry of a predefined grace period following a repayment due date than if made after the expiry of the predefined grace period; (ii) to determine a greater number of credit worthiness points if a repayment is made before a repayment due date than after the due date; and/or (iii) to determine a reduction in credit worthiness points after expiry of a predefined grace period following a repayment due date.

The Credit Enhancement System (CES) of one particular aspect of the invention is a system that integrates:
1. Credit information and history;
2. Credit incentives and credit rating; and
3. Credit insurance.

This integration is facilitated using blockchain technology.

CES Procedure

The basic structure of CES of this aspect is as follows:
1. Customers approved for credit register with the CES network built on blockchain technology.
2. When making a loan repayment instalment (according to a predefined loan repayment schedule), the member additionally contributes a fee (say, 0.1% of the due loan repayment instalment) to the network, which may be regarded as a membership fee. This fee has two components: (i) one to pay for the operation of the system, and (ii) the other to contribute to the insurance fund, referred to as the Credit Enhancement Fund.
3. If the user pays the amount due, comprising loan repayment instalment and membership fee, on-time (or within a grace period thereafter), he or she (or other entity, such as a legal person) earns a stipulated number of credit worthiness points (referred to hereinafter simply as ‘points’). Upon the accumulation of sufficient points, the user is given a high credit worthiness rating (termed, for example, an ‘A rating’), as is described in more detail below.
4. Within the grace period, users who pay on the first day of the grace period are credited with more points and thus potentially enjoy a greater increase in rating than those who pay later within the grace period. This provides an incentive to users to pay as early as possible.
5. Users are rated based on their accumulated points.
6. If a user is late, that is, pays the loan repayment instalment and the membership fee after the grace period expires (by up to a predefined maximum period (e.g. 15 days)), the user is penalized by:
   (a) the deduction of a certain number (or percentage) of points from his or her account (e.g. 20%), resulting in a downgrading of his or her rating; and/or
   (b) the increasing of his or her membership fees, such as by a predefined percentage (e.g. 20%).
However, the penalized user will have the option of restoring his or her rating by paying a fine to the Fund to, in effect, purchase the deducted points and thus to reclaim his or her credit rating. Such an option, however, cannot be repeated more than a predefined maximum number of times, say twice or thrice. If this maximum is reached, the next time the user is late (and hence the maximum would be exceeded), the user is expelled from the network and blacklisted, such that the user cannot rejoin for a predefined finite or indefinite period (the latter amounting to permanent blacklisting).
7. If the payment of the user is late (or missed) owing to an inability on the part of the user to pay on-time (or at all), such as owing to insolvency or an inability to access funds, the network assesses any supporting evidence of the reason for that inability and, if verified, allows the customer to retain his or her rating and points. No penalties apply in this case. For such users, the Fund acts as the guarantor of the customer.
8. The lending institution approves a loan application from a new user, and the network verifies the credit score assigned by the institution to the applicant/application to ensure that the new user meets the requirements of the group or network.

In this way, the Fund functions as a group guarantor and also transmits the loan repayment instalments due to the lending institution on behalf of the individual borrowers (and, should a borrower default on the loan, instead of the borrower). Additionally, the Fund also serves as a credit-rating agency, allowing for credit rating of the individual borrowers.

Credit Rating

Based on the number of points accumulated by the user (so held by the user at any particular time), a rating is issued to describe his or her performance over the previous period. For new users, a minimum period (of 2 years, for example) must pass before the user can be rated by the system. (Until then, the user is considered ‘unrated’.) An example of a suitable rating scheme is shown below:

| Average Points | Rating |
|---|---|
| 98-100 | AAA |
| 94-97 | AA |
| 90-93 | A |
| 86-89 | BBB |
| 81-85 | BB |
| 76-80 | B |
| 61-75 | C |

If the user has been blacklisted (for a predefined finite or indefinite period), he or she is given a rating indicative of the blacklisting (e.g. X), for the duration of the blacklisting.

Late Payment

If a customer is late, that is, pays after the expiry of the grace period by up to a predefined maximum period (e.g. 15 days), then he or she loses a predefined percentage (e.g. 20%) of his or her points, and the contribution or membership fee is increased for that user by a predefined percentage (e.g. 20%). Every delay of up to 15 days will result in such a loss and such an increase in contribution. This can only be repeated a predefined number of times (e.g. twice), but should there be a further occurrence, that borrower is blacklisted unless proved eligible for insurance.

Peer Support and Group Liability

The system provides a flexible environment to adopt peer-based strategies to encourage payment on-time. Users who pay on-time need not disclose their financial data, which protects their privacy. However, the moment a user is late, that user must prove his inability to pay on-time, including disclosing his or her financial position, or otherwise be penalized. Studies have shown that group-liability can inhibit the flexibility of credit flow and become an obstacle to users joining the group. The CEF replaces group liability through the Fund based on blockchain technology. The technology allows group monitoring and indirect pressure to maintain good credit status and protect the reputation of the user (viz. member/borrower). In other words, blockchain technology is able to bring the benefits of joint liability without the associated legal and social costs.

Insolvency

According to this aspect (though this feature may be employed in other aspects and embodiments), blockchain technology is employed in determining whether a late paying user is in financial difficulty or merely procrastinating. This facilitates this determination to be made in a systematic and objective manner. The late paying user submits all required documents needed to support his claim of insolvency. The network verifies these documents but, if the documents do not allow a conclusive determination, a decision as to the legitimacy of the user's claim is made via voting by the other members of the network. If the user/member is proved or held to be insolvent or otherwise incapable of paying for a legitimate reason, the Fund pays all or part of the dues (depending on the liquidity of the Fund). The member becomes indebted to the Fund, and required to repay that debt once the user's financial circumstances permit repayment.

Balance

The Fund achieves its balance through the following formula:

K+Σᵢpᵢ=R+Σᵢmᵢ, (1)

where pᵢ is the contribution made by member i (including membership fees, fines, etc.) to the Fund; K is the capital contributed (if any) by the financial institution(s); mᵢ is the reimbursement to each user; and R is the total reserves of the Fund.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention may be more clearly understood, embodiments are now described, by way of example, with reference to the accompanying drawing (in which like reference numeral indicate similar elements), in which:

FIG. 1 is a schematic view of a blockchain-based credit management system according to an embodiment of the present invention;

FIG. 2 is a schematic view of the CEF computing system of the credit management system of FIG. 1;

FIG. 3 is a schematic view of the user device of the credit management system of FIG. 1;

FIGS. 4A & 4B depict a flow diagram of the operation of the credit management system of FIG. 1;

FIG. 5 is a block diagram illustrating the operation of the credit rating system of the CEF computing system of FIG. 2; and

FIG. 6 is a block diagram illustrating the operation of the credit enhancement fund of the credit management system of FIG. 1.

### DETAILED DESCRIPTION OF THE PREFERRED EMBODIMENTS

The present invention will be further described hereinafter with reference to the accompanying drawings. It is to be understood that specific embodiments described herein are only intended to explain the present invention, and are not taken to limit the present invention. Further, it will be appreciated that the examples provided represent only one of many possible implementations of the present invention. Modifications and variations are possible in light of the above teachings or may be acquired from practicing of the disclosure, without departing from the breadth or scope.

It is also to be understood that the following claims are intended to cover all of the generic and specific features of the invention herein described and all statements of the scope of the invention which, as a matter of language, might be said to fall therebetween.

As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

As used herein, the term “blockchain” refers to a public ledger of all transactions of a blockchain-based network. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a transaction amount, such that the blockchain records how much is attributable to a specific address. In some instances, the transactions are financial and while in others, they are not financial, or might include additional or different information, such as a source address, timestamp, etc. In some embodiments, a blockchain may also alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction.

Overview

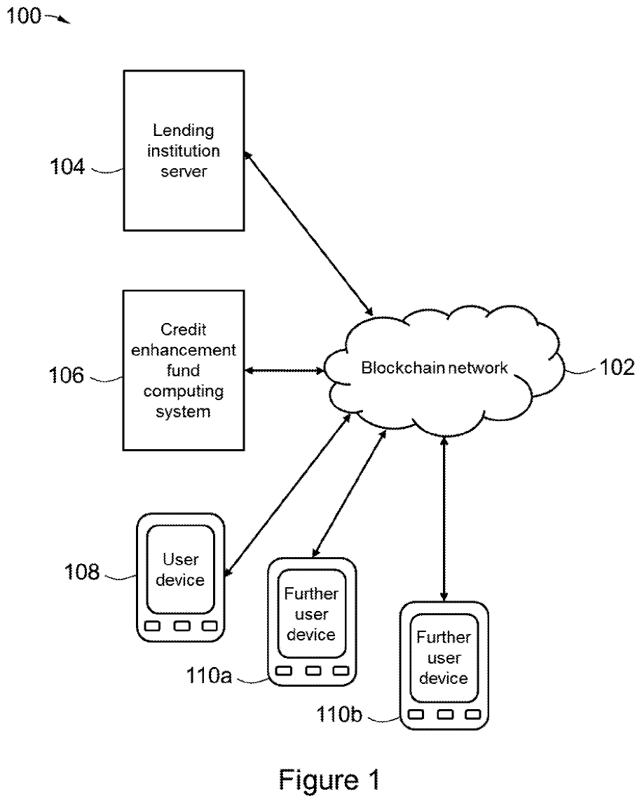

FIG. 1 is a schematic view of a blockchain-based credit management system (CES) 100 according to an embodiment of the present invention, depicted with a lending institution server that provides credit via system 100. System 100 includes a blockchain network 102, a credit enhancement fund (CEF) computing system 106, and a user device 108. Lending institution server 104, CEF computing system 106 and user device 108 communicate via blockchain network 102, but—in addition—one or more of lending institution server 104, CEF computing system 106 and user device 108 can constitute a portion or portions of blockchain network 102, or indeed the entirety of blockchain network 102. In all such embodiments, communication—though via blockchain network 102—involves the use of a suitable communications network, most generally the internet.

System 100 may also (and generally will) have one or more further users (e.g. individuals such as employees, companies such as banks, household members and landowners) with respective further user devices (represented by further user devices 110a, 110b), in addition to the lending institution (with lending institution server 104), CEF (with CEF computing system 106), and user (with user device 108). System 100 thus may include further user devices 110a, 110b and, optionally, blockchain network 102 can include one or more of further user devices 110a, 110b. However, for simplicity, the following description refers to only the user of user device 108. It should be noted that user device 108 and further user devices 110a, 110b, though depicted in the figure as portable computing devices, can assume any suitable form, configured to perform the functions discussed herein, such as a desktop computer, laptop computer, notebook computer, tablet computer, mobile telephone, smartphone, smart television, wearable computing device, implantable computing device, etc.

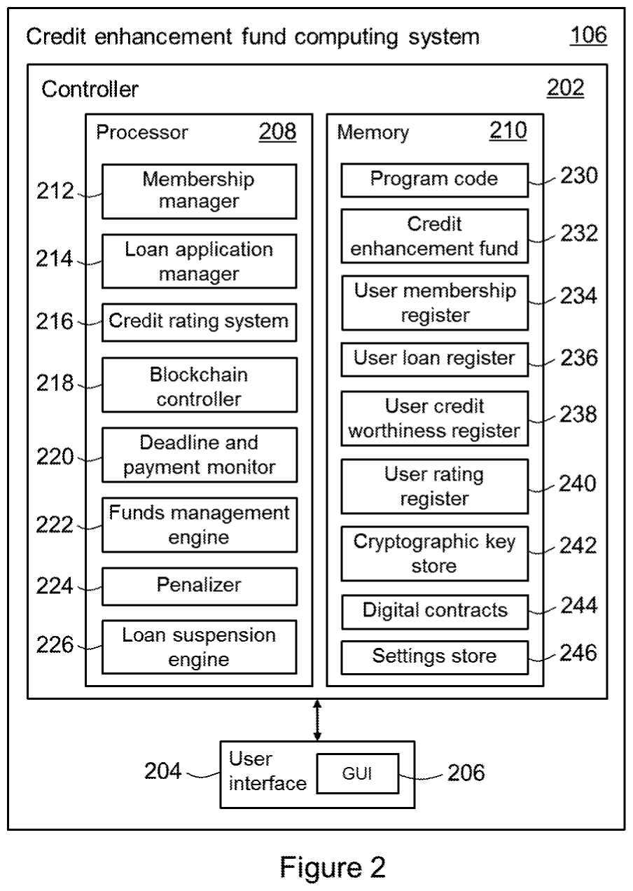

FIG. 2 is a schematic view of CEF computing system 106 of system 100. Referring to FIG. 2, CEF computing system 106 includes a controller 202 and a user interface 204 (which includes a GUI 206). Controller 202 includes a processor 208 and memory 210. The term “processor” is used to refer to any device or devices that can process program instructions (such as in the form of program code stored in memory 210) and may comprise a microprocessor, microcontroller, programmable logic device or other computational device, a general purpose computer (e.g. a PC) or a server. Typically, memory 210 includes both volatile and non-volatile memory and more than one of each type of memory, with such memories being collectively represented by memory 210.

Processor 208 of CEF computing system 106 includes a membership manager 212 configured to monitor membership applications, a loan application manager 214 configured to monitor loan applications, a credit rating system 216, a blockchain controller 218 configured to add events to a blockchain on blockchain network 102, a deadline and payment monitor 220, a funds management engine 222, a penalizer 224 configured to apply penalties when a user has breached certain predefined loan or repayment conditions, and a loan suspension engine 226. The functions of these components of processor 208 are described further below. It should be noted that these components are configured to initiate events or transactions in blockchain 102, but that many of the operations described below are implemented by digital contracts.

A ‘digital contract’ (sometimes referred to a ‘Smart Contract’) is a self-executing contract with the terms of the agreement between buyer and seller being written into lines of code. The code and the agreements contained therein exist across a distributed, decentralised blockchain network, blockchain network 102 being an example of such a network. Thus, for example, the loans of this embodiment (though not in all other embodiments) are in the form of so-called ‘smart loans’, being loans governed by digital contracts on blockchain network 102. In some other embodiments, the loans are not smart loans, but instead are conventional loans, but with repayments effected using system 100. In addition, the functions of these components may, where suitable, be performed by deploying appropriately configured digital contracts in blockchain network 102 (as is so for the components of user device 108). For example, the role of deadline and payment monitor 220 may be provided by one or more digital contracts recorded in blockchain network 102, that recordal being initiated by deadline and payment monitor 220.

Memory 210 includes program code 230, credit enhancement fund 232, user membership register 234, user loan register 236, a user credit worthiness register 238, a user rating register 240, a cryptographic key store 242 (for storing the cryptographic keys required to access all blockchains in blockchain network 102 to which CEF computing system 106 requires access to perform its functions as described herein), a digital contracts store 244 (where precedent or template digital contracts are stored, to be used when needed), and a settings store 246.

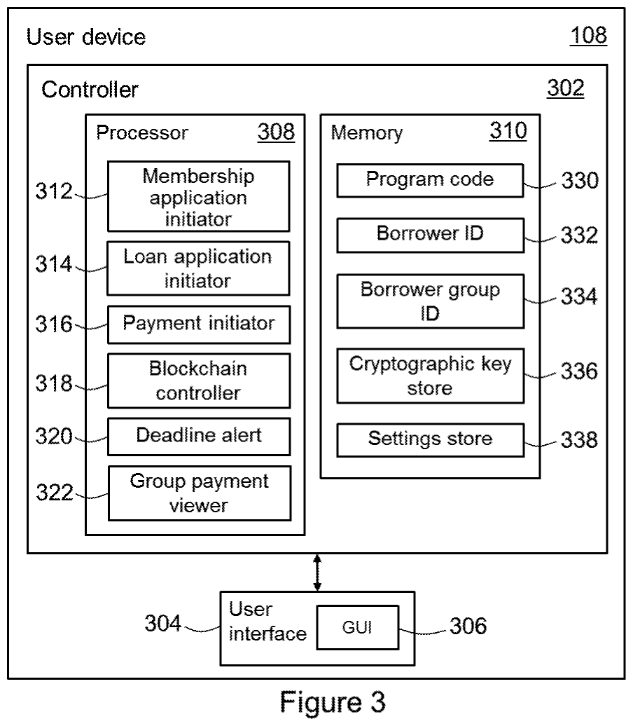

FIG. 3 is a schematic view of user device 108 of system 100. Referring to FIG. 3, user device 108 includes a controller 302 and a user interface 304 (which includes a GUI 306). Controller 302 includes a processor 308 and memory 310. The term “processor” is again used to refer to any device or devices that can process program instructions (such as in the form of program code stored in memory 310) and may comprise a microprocessor, microcontroller, programmable logic device or other computational device, a general purpose computer (e.g. a PC) or a server. Memory 310 includes both volatile and non-volatile memory and may include more than one of each type of memory, with such memories being collectively represented by memory 310.

Processor 308 of user device 108 includes a membership application initiator 312 configured to initiate a membership application, a loan application initiator 314 configured to initiate a loan application, a payment initiator 316 configured to initiate payments (such as to make a loan repayment instalment and/or pay a membership fee), a blockchain controller 318 configured to add events to a blockchain on blockchain network 102, a deadline alert 320 configured to issue deadline alerts (or reminders) to the user via GUI 306 (the alerts being generated by user device 108, received by user device from CEF computing system 106 or generated by the operation of a digital contract on blockchain network 102), and a payment or transaction viewer in the form of a group transaction viewer 322. The functions of these components of processor 308 are described further below. Memory 310 includes program code 330, a borrower ID 332 (for storing the user's unique ID as a borrower within system 100), a borrower group ID 334 (for storing the user's borrower group ID within system 100), a cryptographic key store 336 (for storing the cryptographic keys required to access all blockchains in blockchain network 102 to which user device 108 requires access to perform its functions as described herein) and a settings store 338.

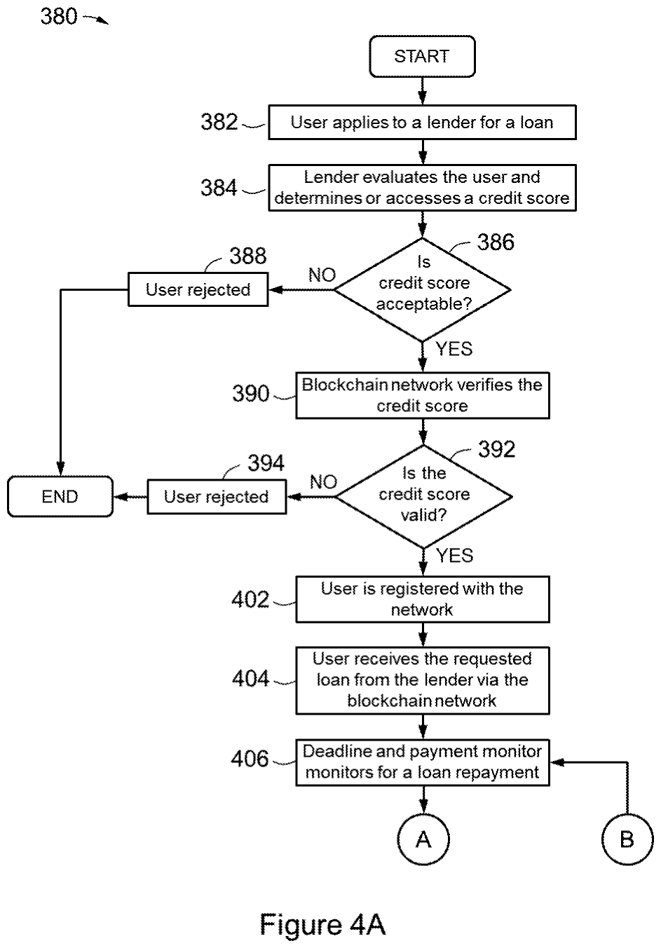

FIGS. 4A and 4B depict a flow diagram 380 illustrating the operation of system 100. It should be noted that flow diagram depicts the situation of a new user applying for a loan through CES 100 for the first time, and hence initially as a non-member. If already a member, some steps may be omitted. Referring to FIG. 4A, at step 382 the user controls user device 108 to submit an application for a loan: the user controls user device 404 to submit an application for a loan, by controlling loan application initiator 314 to submit, using blockchain controller 318, a loan application as a transaction or event to blockchain 102. This event is recognized by loan application manager 214 and by lending institution server 104, and includes any information about the user pertinent to the issuing of the loan. This information is typically drawn from blockchain network 102, but if additional information is required, that information may be drawn from an external credit rating agency. At step 384, the lender receives and evaluates the user's acceptability by determining or accessing (e.g. from an external credit rating agency) a credit score.

As will be appreciated by those skilled in the art, a range of credit scores may be deemed acceptable, but a lower credit rating (from an external credit agency) may result in a lower borrowing limit, a higher cost of financing, and/or a less ‘friendly’ repayment plan. A lower credit rating may also affect the user when he or she seeks to register or applies for a loan with a different lending institution on a subsequent occasion: some lending institutions may impose a minimum credit rating for new borrowers, or may require that the borrower have more in terms of savings/liquidity should he have a less desirable credit rating. At step 386, the lender determines whether the credit score is acceptable. If not, processing continues at step 388, where the user is rejected. Processing then ends.

If, at step 386, the lender determines that the credit score is acceptable, processing continues at step 390 where blockchain network 102 checks the validity of the credit score and hence the eligibility of the user to become a member (that is, have access to and have transactions, etc, recorded in) blockchain network 102. Blockchain network 102 does so, generally, using one or more digital contracts. In some embodiments, this eligibility depends only on those digital contracts determining that the user does not have an existing credit rating (reflected in blockchain network and mirrored in user rating register 240), such as an “X” rating, that blacklists the user from joining (or rejoining) the CEF network. In certain embodiments, the eligibility is assessed by membership manager 212 accessing an external credit rating for that user maintained by an external credit rating agency and, if membership manager 212 finds that the user has an acceptable external credit rating, it adds an event to this effect to blockchain network 102. This embodiment employs both of these approaches such that, if the user is eligible, two transactions or events will be recorded in blockchain network 102.

If, at step 392, it is detected that the credit score for that user has not been validated so the user found to be ineligible, processing continues at step 394, where the user is rejected. Processing then ends. If, at step 392, it is determined that the credit score has been validated so the user found to be eligible, processing continues at step 402 where the user is registered with the CEF network, thus becoming a member of the CEF network; this eligibility and membership is reflected in and can be ascertained from blockchain network 102. That is, blockchain network 102 verifies that the user's credit score (as assessed by the lender) is valid and the user (now member) will be an acceptable risk to the group. The lender performs the credit scoring in accordance with its own methodology and risk-parameters, while blockchain network 102 verifies the validity of the final score. To protect the privacy of the lender's scoring methods, and to ensure the validity of credit score, and that the data used in their scoring process are authentic and secure, the verification process may follow, for example, techniques such as:
i) Challenge-response verification, whereby CES 100 interacts with the lender's credit scoring script without disclosing the script itself, in order to validate the score.
ii) Through CES 100 interaction with different data sets of different customers, without necessarily disclosing the data, to validate the authenticity of the data.
   In this manner, blockchain network 102 is able ensure the ex-ante creditworthiness of the new member, meanwhile preserve privacy of the institution's scoring technique.

In response, membership manager 212 controls blockchain controller 218 to register the user (including the user's details, such as name, address, bank account number and a member ID (and, optionally, a borrower group ID if the user is assigned to a borrower group in blockchain network 102). If, optionally, the user is assigned to a borrower group, the selection of the borrower group may be made in any suitable manner. For example, existing members of a group may nominate a new member (of the system) for membership of their group; a new member (of the system) may be assigned to a particular group based on various criteria (set by, for example, the lending institution or the CEF), such as one or more characteristics of the new member (e.g. an individual versus a corporate member; existing credit rating); or a combination of both nomination and assignment. Optionally, membership manager 212 add the user's details to user membership register 234 as an off-line backup. In some embodiments the user is registered as a member but is not registered in a borrower group, but in this embodiment the user is registered in a borrower group in order to gain the benefits of peer support. The members of each borrower group can view the payment details of all members of that borrower group (these payments also being stored in the blockchain network 102), which it is envisaged may encourage timely repayments owing to peer-group psychology. This is facilitated by providing the members of the borrower group (who thus share a common borrower group ID 334) with the requisite cryptographic keys in cryptographic key store 336.

At step 404, the lender issues the loan, and lending institution server 104 records that loan issuance on blockchain network 102, including the loan's details and a repayment schedule. Loan application manager 214 responds to the loan issuance by updating user loan register 236 with the loan's details including a repayment schedule that includes or implies one or more due dates for repayments. User device 108 detects the loan issuance as an event in blockchain network 102 controls deadline alert 320 to alert the user to the issuance of the loan (and hence that, in due course, lending institution server 104 will deposit or initiate the depositing of the borrowed funds to the bank account of the user), of the deadline for making the first repayment instalment, and of the magnitude of the payment (comprising repayment instalment and membership fee) due by that deadline.

In some embodiments, the monetary currency employed in system 100 including, in particular, for providing loans and making repayments, is a blockchain-based cryptocurrency, such as in the form of smart tokens. In other embodiments, the loans are in the form of a standard currency. In some embodiments, the loan is issued in one currency (e.g. standard currency) but repaid in another (e.g. cryptocurrency), or on either (e.g. cryptocurrency or standard currency).

At step 406, deadline and payment monitor 220 of CEF computing system 106 (or alternatively a suitable digital contract in blockchain network 102 configured to perform the same function) monitors blockchain network 102 for that payment (comprising, as described above, a loan repayment instalment and the membership fee), based on the applicable repayment schedule. This monitoring continues until a predefined period after the nominal repayment due date, comprising a grace period (Tg) and an additional default period (Td) such that, after (Tg+Td), the user is deemed to have failed to make that payment. (Both Tg and Td are stored in settings store 246, and can be set by an administrator of CEF computing system 106.) Referring to FIG. 4B, if, at step 408, deadline and payment monitor 220 (or, in some embodiments, a digital contract in blockchain network 102) has detected a payment, processing continues at step 410 where funds management engine 222 of CEF computing system 106 initiates the recording in blockchain network 102 of the transfer of the user's membership fee (e.g. 0.1% of the loan repayment instalment) in the manner described below, and the transfer of the balance of the payment (being the loan repayment instalment) to the lending institution.

For example, if the loan repayment instalment were $500, and the membership fee were set at 0.1% of the loan repayment instalment (hence $0.50 in this example), the payment due would be $500.50. If blockchain network 102 detects a shortfall (when compared with the details in the applicable repayment schedule), the funds are credited as described above, but blockchain network 102—such as by employing a digital contract—monitor for a further payment (or further payments) from the user until the full due amount has been paid. Only when the full amount has been paid does blockchain network 102 record that repayment instalment as having been paid and that the user is in good standing as a member. In general, the loan repayment instalment constitutes a transaction, so blockchain controller 218 records the details of this transaction in a blockchain in blockchain network 102, and the payment of the membership fee also constitutes a transaction, the details of which blockchain controller 218 records in a blockchain in blockchain network 102—which may be distinct from the former blockchain. In this embodiment, however, both sets of details are recorded in the same blockchain in blockchain network 102, whether treated as arising from a single transaction or from two distinct transactions.

The user's membership fee is intended to pay for the cost of operating CEF computing system 106 and to contribute to the credit enhancement fund. Hence, step 410 includes transferring the user's membership fee accordingly. A predefined portion (which may be a percentage of the fee) of the user's membership fee is thus transferred to an account associated with the maintenance, etc., of CEF computing system 106, and the balance of the membership fee is credited to the credit enhancement fund account. Details of the credit enhancement fund are stored in credit enhancement fund 232 (though the funds themselves may be deposited at a suitable financial institution, such as the lending institution). The credit enhancement fund amounts to a mutual insurance or loan insurance fund. (Seed capital contributed by the lender can also contribute to the solvency of this fund.) Additionally in this step, blockchain controller 218 updates blockchain network 102 with the details of the payment including the contribution to the credit enhancement fund.

Details of the payment, being stored in blockchain network 102, are accessible to parties with the appropriate cryptographic keys. All members of a borrower group (and thus having the same borrower group ID) are able to view the payment information of all members of that borrower group. The user does this by controlling group transaction viewer 322, which has permission to access the cryptographic keys (in cryptographic key store 336) required to access payment information stored in blockchain network 102 of payment information pertaining to payments (including his or her own payments) made by all users/members with the same borrower group ID 334 as has the user.

Processing continues at step 412, where a digital contract on blockchain network 102 determines whether determines from records in blockchain network 102 whether the payment was made in a timely manner, that is, by the applicable deadline or before the expiry of the grace period (Tg) thereafter, by comparing the date of the payment with the repayment schedule and Tg. (In another embodiment, the determination of the timeliness of the payment is made by penalizer 224.) If it is determined that the payment was a timely payment, processing continues at step 414, where blockchain network 102 issues credit worthiness points to the user based on the timeliness of repayment.

The assigned points are recorded in a blockchain in blockchain network 102. This blockchain may be the same blockchain in which are recorded the loan repayment instalments, or a separate credit rating blockchain of blockchain network 102. Optional credit rating system 216 also maintains entries of the user's points and credit rating in, respectively, user credit worthiness register 238 and user rating register 240. (In an alternative embodiment, credit rating system 216 determines and awards credit worthiness points and credit ratings.) The number of points awarded to the user depends on the timeliness of the payment. The maximum number of points is awarded for a payment made by the repayment deadline, and a reduced and progressively diminishing number of points is awarded thereafter until the expiry of the grace period.

At step 416, blockchain network 102 determines whether the user has been registered as a member for a predefined period (in this example, two or more years). If so, processing continues at step 418 where blockchain network 102 assigns the user a credit rating (e.g. AAA, AA, A, BB, etc), or has his or her credit rating updated, based on the total points accumulated or held by the user over a predefined previous time period—in this example, two years. In an alternative embodiment, blockchain network 102 assigns such a credit rating only when that credit rating is accessed or requested at a later time (such as when the user applies for a new loan). It should also be noted that, in both of these embodiments, a credit rating is issued to describe the user's performance over the predefined previous time period, so—for new users—a minimum period (e.g. 2 years) must pass before the user is rated in this manner. Until then, the system relies on conventional ratings accessed from an external credit rating agency. Processing then continues at step 420, where blockchain network 102 determines whether the loan has been repaid (and hence that no further payments will be required by the lender): if the loan has not been repaid, processing returns to step 406. If the loan has been repaid, processing continues at step 422, where blockchain network 102 determines whether the user owes the credit enhancement fund for any payments made to the lender from the fund on behalf of the user (cf. steps 436 and 438, described below). If the user indeed owes the fund for any such payments, processing returns to step 406. Otherwise, processing of this loan ends.

In this embodiment, there is a predefined maximum number of times the user is permitted to pay the requisite payment after the expiry of the grace period (e.g. twice or thrice), after which he or she is blacklisted and/or expelled from blockchain network 102. This maximum is stored in settings store 246. Other embodiments may omit such a limit, or apply an escalating penalty for such late payment. However, in this embodiment, if, at step 412, penalizer 224 ascertains (whether from blockchain network 102 or directly) that the payment was not made in a timely manner, that is, was made after the expiry of the grace period (Tg), processing continues at step 424 where penalizer 224 determines whether this occurrence of payment made in a untimely manner is less than or equal to a maximum acceptable number of such occurrences (in this example, this maximum being two). If this occurrence is less than or equal to that maximum, processing continues at step 426, where penalizer 224 imposes a penalty and a fine, and monitors—whether directly or by recording a suitable digital contract in blockchain network 102—for the collection of the fine. In this embodiment, the penalty comprises the deduction of a predefined number of credit worthiness points (such that a downgrading of the user's rating may result, such as by one or two tiers), and the increasing of the user's membership fee (by, for example, a predefined percentage each time this occurs). In some other implementations the penalty is levied in standard currency by default or as an alternative at the election of the user. The fine is, in this embodiment, expressed as standard currency or cryptocurrency, but alternatives are possible (such as in points or an agreement to pay a higher membership fee in future, or a combination of any of these).

Blockchain network 102 monitors for the payment of the fine until it detects that the fine has been paid or until a predefined timeout period (stored in settings store 246) has elapsed without payment. Thus, if at step 428 penalizer 224 ascertains (whether directly or with a digital contract in blockchain network 102) that the fine has been paid before the timeout period expires, processing continues at step 430 where penalizer 224 initiates the reversing of the credit points component of the penalty and processing continues at step 414. If, at step 428, penalizer 224 ascertains (whether directly or with a digital contract in blockchain network 102) that the fine was not paid before the timeout period expired, processing continues at step 414.

If, at step 424, penalizer 224 determines that the occurrence of a payment made in a untimely manner is greater than the maximum acceptable number of such occurrences, processing continues at step 432, where loan suspension engine 226 blacklists the user (including conferring a credit rating of X), controls blockchain controller 218 to reflect these circumstances in blockchain 102, and controls funds management engine 222 to initiate the outstanding repayment using funds from credit enhancement fund 232. Processing then ends.

If, at step 408, deadline and payment monitor 220 fails to detect a loan repayment before a predefined timeout period (stored in settings store 246) has elapsed, processing continues at step 434 where loan suspension engine 226 monitors for the uploading to blockchain network 102 of evidence of the user's inability to make the repayment of a type deemed exonerating (such as evidence of insolvency). If, before a predefined period expires, such evidence is uploaded and verified by blockchain network 102 as valid, processing continues at step 436 where loan suspension engine 226 suspends the loan (that is, initiates an suspension or amendment of the user's repayment schedule); the points and ratings of the user are unaffected, and no penalty or fine is imposed. In some embodiments, the solvency of the user is determined by blockchain network 110 via one or more digital contracts, and if the results are inconclusive, by voting by either other members of the immediate borrower group or members of system 100 (according to embodiment).

Processing then continues at step 438, where loan suspension engine 226 controls funds transfer engine 222 to initiate the transfer of the outstanding repayment instalment amount from the credit enhancement fund to the lending institution. Processing then continues at step 420. As mentioned above, in this embodiment the user is required (at step 434) to have provided evidence of an inability to pay every time a payment is due. This does not necessarily require the submission of that inability every time a payment is due (e.g. monthly); this evidence may be treated valid for a predefined period (e.g. 6 or 12 months) from submission, such that—at step 434—the enquiry of whether valid evidence has been submitted may be satisfied by the existence of evidence submitted any time in that predefined period before the time that step is performed. However, if a greater period has elapsed, the previous evidence is deemed to be stale and fresh evidence is required. In some embodiments, fresh evidence is required more frequently (e.g. every 6 months) that the loan repayment frequency (e.g. every 12 months); though not shown in this figure, in such embodiments loan suspension engine 226 polls for fresh evidence with that frequency (e.g. every 6 months). In all such cases, when no valid evidence of an inability to pay is found to have been uploaded (including)—whether at step 434 or through such regular polling by loan suspension engine 226—the user's obligation to pay recommences, either with a schedule identical to the previous schedule modified by being moved back by the suspension period or with that modified schedule but advanced to (or a predefined period before) the next repayment due date. This repayment obligation includes both the remaining loan repayments (if any) and the repayments missed by the user but made by the credit enhancement fund. The subsequent repayments are thus directed accordingly, initially to the lender and subsequently to the credit enhancement fund. Thus, the user must repay the fund once able to do so.

If, in step 434, loan suspension engine 226 does not detect that suitable, valid evidence has been uploaded, processing continues at step 432 (described above).

Credit Rating System

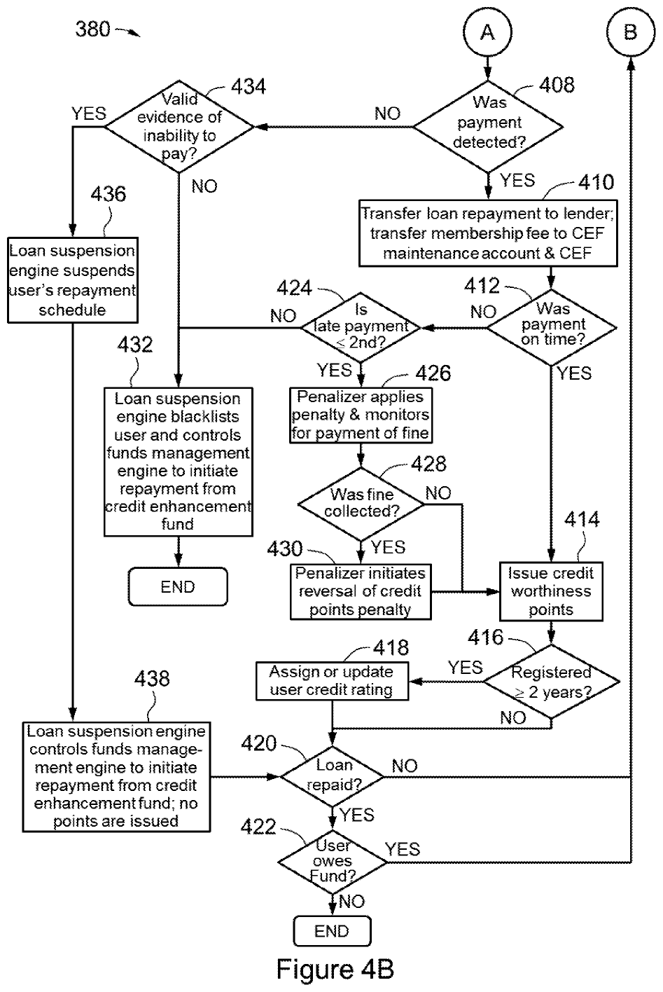

FIG. 5 is a schematic and simplified architectural view of the operation of credit rating system 216 of CEF computing system 106.

Referring to step 502, the user controls user device 108 to initiate his or her payment (comprising loan repayment instalment and membership fee) before the grace period expires. Following this, at step 504, blockchain network 102 responds by issuing points to the user. At step 506, the user's points are tallied, and at step 508, blockchain network 102 assigns a credit rating to the user based on the accumulated points.

If blockchain network 102 detects that the user has made his or her payment but after the grace period expires, as shown at step 510, blockchain network 102 responds—at step 512—by applying a penalty including deducting points from the user and downgrading the user's credit rating. The user then controls user device 108 to pay the fine (step 514), only following which—at step 516—does blockchain network 102 issue points to the user and, as the fine has been paid, restore the user's credit rating. Processing continues at step 506, where the points deducted and issued respectively in steps 512 and 516 are tallied in determining the user's accumulated points.

If, as shown at step 518, the user is unable to pay his contribution amount (e.g. is insolvent), the user can—at step 520—control user device 108 to submit supporting documents to blockchain network 102 as evidence of an acceptable excuse for not paying (such as evidence of insolvency). If, at step 522, blockchain network 102 is able to verify the insolvency of user, the points and ratings of the user are unaffected, and no penalty is imposed.

Credit Enhancement Fund

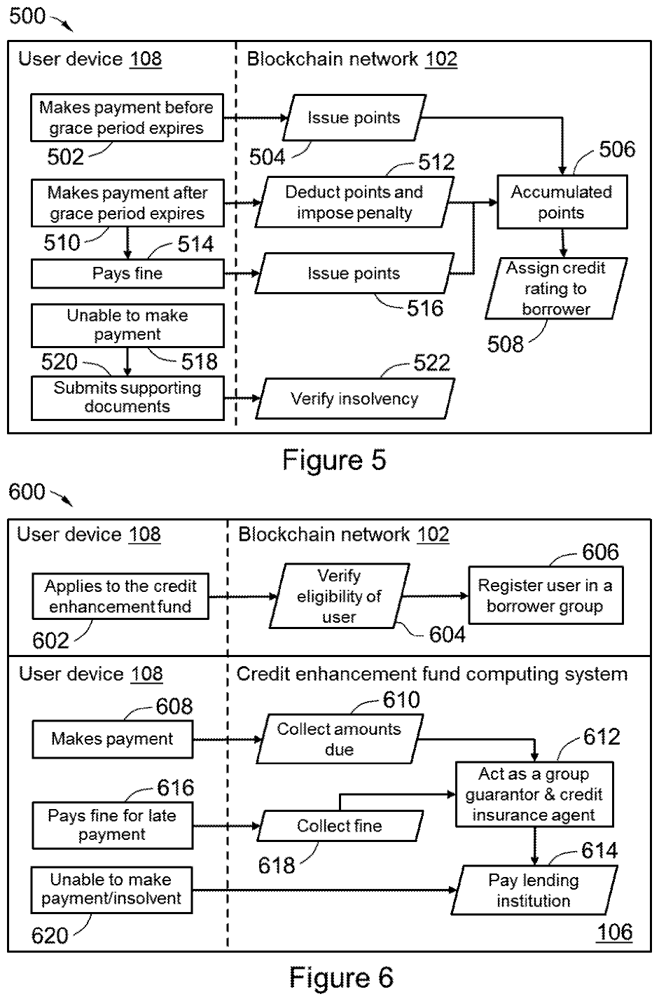

FIG. 6 is a schematic and simplified architectural view of the operation of the Credit Enhancement Fund of CEF computing system 106.

At step 602, the user controls user device 108 to submit an membership application to CEF computing system 106. At step 604, blockchain network 102 checks the eligibility of the user, based on at least the credit rating of the user, and—if the user is found to be eligible—at step 606, blockchain network 102 registers the user in a borrower group.

At step 608, the user controls user device 108 to initiated payment of his or her loan repayment instalment and membership fee before the grace period expires, and at step 610, CEF computing system 106 detects the payment. As shown at step 612, the CEF acts as a group guarantor and credit insurance agent for the users in the respective borrower group. At step 614, CEF computing system 106 (on behalf of the user) initiates payment to the lending institution of the loan repayment instalment and retains the membership fee, with the CEF receiving its share of the membership fee.

If the user has been penalised by blockchain network 102 for not making the requisite payment by the expiry of the grace period, a fine is imposed and, at step 616, user controls user device 108 to initiate payment of the fine (whether in standard currency, cryptocurrency, points or otherwise). At step 618, CEF computing system 106 detects payment of the fine. Again, it should be noted that the payment of the fine to restore the credit points (and hence rating) is not obligatory. The user may choose to keep the lower rating for whatever reason.

The Credit Enhancement Fund acts as a group guarantor and credit insurance agent for the group using the collected membership fees.

At step 620, if the user faces financial difficulty (of a recognized or accepted kind, such as insolvency), such that the user is unable to pay his or her contribution, CEF computing system 106 is configured to initiate payment of the user's loan instalment to the lending institution (if the credit enhancement fund has sufficient funds). In some embodiments, the user—in this situation—becomes indebted to the credit enhancement fund (either in the sum of the loan instalment paid by the CEF computing system 106 or that sum plus the outstanding membership fee) and obliged to repay that debt once the user's financial conditions permit repayment (e.g. once solvent again).

Thus, system 100 provides a flexible environment to adopt peer-based strategies to encourage payment on-time without incurring the costs and frictions associated with group-liability. System 100 replaces group liability through the CEF using blockchain technology, and can bring the benefits of joint liability without the associated legal and social costs.

Computer System Architecture

It should be further appreciated that, in the embodiments described above, computing devices 104, 106 and/or 108 may—in various variations thereof—be implemented using hardware, software, firmware, non-transitory computer readable media having instructions stored thereon, or a combination thereof and may be implemented in one or more computer systems or other processing systems. Hardware, software, or any combination thereof may embody modules and components used to implement the methods as described in this present application.

When programmable logic is used, that logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the computing devices of the embodiments above described.

A processor as discussed herein may be a single processor, a plurality of processors, or combinations thereof. Processors may have one or more processor “cores.” The terms “computer program medium,” “computer readable medium,” “non-transitory computer readable medium,” and “computer usable medium” as discussed herein are used to generally refer to tangible media.

Various embodiments of the present application are described in terms of the examples of FIGS. 2 to 4. After reading this description, it will be apparent to a person skilled in the relevant art how to implement the present application using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The processors 208, 308 may be special purpose or general purpose processors specifically configured to perform the functions discussed herein. They may be operably connected to an external telecommunications network via respective communication controllers, in turn connected to transmitters and receivers. The network may be any network suitable for performing the functions as disclosed herein and may comprise a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. Exemplary transmitters and receivers include a modem, a network interface (e.g., an Ethernet card), a communications port, a PCMCIA slot and card, etc.

Software and data transferred via transmitters and receivers may be in the form of signals, which may be electronic, electromagnetic, optical, or other signals as will be apparent to persons having skill in the relevant art. The signals may travel via a communications path, which may be configured to carry the signals and may be implemented using wire, cable, fibre optics, a phone line, a cellular phone link, a radio frequency link, etc.

Memory 210 and 310 (e.g., random access memory, read-only memory, etc.), and may also include or be accompanied by storage comprising a hard disk drive and a removable storage drive, such as a floppy disk drive, a magnetic tape drive, an optical disk drive, a flash memory, etc. In some embodiments, this storage includes alternative means for allowing computer programs or other instructions to be loaded into the computing devices 104, 106 and/or 108, such as a removable storage drive and an interface. Examples of such means may include a program cartridge and cartridge interface (e.g., as found in video game systems), a removable memory chip (e.g., EEPROM, PROM, etc.) and associated socket, and other removable storage units and interfaces as will be apparent to persons having skill in the relevant art.

Data stored in computing devices 104, 106 and/or 108 may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

Computing devices 106 and/or 108 may further include output devices, configured to allow data to be transferred between the respective device and user interfaces 204, 304. Such an output device comprises, for example, a high-definition multimedia interface (HDMI), digital visual interface (DVI), video graphics array (VGA), etc. User interfaces 204, 304 may include any suitable type of display for displaying data transmitted via the output device, such as a cathode ray tube (CRT) display, liquid crystal display (LCD), light-emitting diode (LED) display, capacitive touch display, thin-film transistor (TFT) display, etc.

User interfaces 204, 304 also comprise input devices such as touch panels, keyboards, mice, joysticks, digital cameras and microphones. Audio input devices (such as the microphones as mentioned) may be used for purposes including speech recognition. Image input devices (such as the digital cameras as mentioned) may be used for purposes including gesture recognition.

Computer program code and computer readable medium may refer to memories, such as memory 210, 310, which may be memory semiconductors (e.g., DRAMs, etc.). These computer program code 230, 330 provide software to the respective computing devices 106, 108. Such computer program code, when executed, controls devices 106, 108 to implement at least in part, the methods discussed herein.

Processors 208, 308, as described above, comprise modules or engines configured to perform the functions of computing devices 106, 108 respectively. Each of the modules or engines may be implemented using hardware and, in some instances, may also utilise software, such as corresponding to program code stored in memory 210, 310, respectively. In such instances, program code may be compiled by processors 208, 308 (e.g., by a compiling module or engine) prior to execution by the hardware of computing devices 106, 108. For example, the program code 230, 330 may be source code written in a programming language that is translated into a lower level language, such as assembly language or machine code, for execution by processors 208, 308 and/or any additional hardware components of devices 106, 108. The process of compiling may include the use of lexical analysis, preprocessing, parsing, semantic analysis, syntax-directed translation, code generation, code optimization, and any other techniques that may be suitable for translation of program code into a lower level language suitable for controlling devices 106, 108 to perform the functions disclosed herein. It will be apparent to persons having skill in the relevant art that such processes result in devices 106, 108 being one or more specially configured computer systems uniquely programmed to perform the functions discussed above.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

1. A computer-implemented blockchain-based credit management method, comprising:
receiving one or more loan repayments from a user in a first transaction, the loan repayments being in respect of a first loan issued by a lender;
receiving a fee from the user in a second transaction associated with the first transaction;
transferring the loan repayments to the lender;
transferring the fee to a loan insurance fund;
registering at least the first transaction in a first blockchain of a blockchain network;
determining a timeliness of the first transaction relative to a first loan repayment schedule;
determining a number of credit worthiness points based on at least the timeliness of the first transaction relative to the first loan repayment schedule;
issuing the number of credit worthiness points to the user and associating the number of credit worthiness points with the user in a third transaction; and
registering the third transaction, including the number of credit worthiness points associated with the user, in a second blockchain of the blockchain network.

2. The method as claimed in claim 1, further comprising determining a credit rating for the user based on at least a total number of credit worthiness points allocated to or held by the user, as registered in the second blockchain, and associated with the user.

3. The method as claimed in claim 1, including registering the second transaction in a third blockchain of the blockchain network or registering the second transaction in the first blockchain.

4. The method as claimed in claim 1, further comprising paying to the lender from the loan insurance fund:
a) one or more outstanding loan repayments in response to receipt of data indicative of the user omitting to make the corresponding loan repayments; or
b) some or all of an outstanding balance of the first loan in response to receipt of verification data indicating that the user has been verified as unable to make one or more loan repayments.

5. The method as claimed in claim 2, further comprising registering the credit rating in the first blockchain, in the second blockchain, and/or in a credit rating blockchain of the blockchain network.

6. The method as claimed in claim 1, further comprising the blockchain network verifying as valid a credit score calculated or accessed by the lender of a loan application of the user, and approving the user to join the blockchain network when the credit score is valid.

7. The method as claimed in claim 1, including determining a greater number of credit worthiness points when a repayment is made before expiry of a predefined grace period following a repayment due date than when made after the expiry of the predefined grace period.

8. The method as claimed in claim 1, further determining a reduction in credit worthiness points after expiry of a predefined grace period following a repayment due date.

9. A computer program comprising computer program code configured, when loaded into a computing system and executed thereon, to control the computing system to perform the method as claimed in claim 1.

10. A computer readable medium, comprising the computer program of claim 9.

11. A blockchain-based credit management system, comprising:
a funds management engine configured to receive one or more loan repayments from a user in a first transaction, the loan repayments being in respect of a first loan issued by a lender, to receive a fee from the user in a second transaction associated with the first transaction, to transfer the loan repayments to the lender, and to transfer the fee to a loan insurance fund;
a blockchain controller configured to register at least the first transaction in a first blockchain of a blockchain network; and
a credit rating system configured to determine a timeliness of the first transaction relative to a first loan repayment schedule, to determine a number of credit worthiness points based on at least the timeliness of the first transaction relative to the first loan repayment schedule, to issue the number of credit worthiness points to the user and to associate the number of credit worthiness points with the user in a third transaction;
wherein the blockchain controller is further configured to register the third transaction, including the number of credit worthiness points associated with the user, in a second blockchain of the blockchain network.

12. The system as claimed in claim 11, wherein the credit rating system is further configured to determine a credit rating for the user based on at least a total number of credit worthiness points allocated to or held by the user, as registered in the second blockchain, and to associate the credit rating with the user.

13. The system as claimed in claim 12, wherein the blockchain controller is further configured to register the credit rating in the first blockchain, in the second blockchain, and/or in a credit rating blockchain.

14. The system as claimed in claim 11, wherein the blockchain controller is further configured to register the second transaction in a third blockchain of the blockchain network, or to register the second transaction in the first blockchain.

15. The system as claimed in claim 11, wherein the funds management engine is further configured to pay to the lender from the loan insurance fund one or more outstanding loan repayments in response to receipt of data indicative of the user omitting to make the corresponding loan repayments.

16. The system as claimed in claim 11, wherein the funds management engine is further configured to pay to the lender from the loan insurance fund some or all of an outstanding balance of the first loan in response to receipt of verification data indicating that the user has been verified as unable to make one or more loan repayments.

17. The system as claimed in claim 12, further comprising registering the credit rating in the first blockchain, in the second blockchain, and/or in a credit rating blockchain of the blockchain network.

18. The system as claimed in claim 11, further comprising the blockchain network:
a) verifying as valid a credit score calculated or accessed by the lender of a loan application of the user; or
b) approving the user to join the blockchain network when the credit score is valid.

19. The system as claimed in claim 11, further comprising a loan application manager configured to receive a loan application from the user for a second loan subsequent to the determining of the credit rating, wherein the loan application is approved subject to the credit rating being at or above a predefined threshold.

20. The system as claimed in claim 11, wherein the credit rating system is further configured:
a) to determine a greater number of credit worthiness points if a repayment is made before expiry of a predefined grace period following a repayment due date than if made after the expiry of the predefined grace period;
b) to determine a greater number of credit worthiness points if a repayment is made before a repayment due date than after the due date; and/or
c) to determine a reduction in credit worthiness points after expiry of a predefined grace period following a repayment due date.
